(19) United States
(12) Patent Application Publication
(10) Pub. No.: US 2025/0232406 A1
(43) Pub. Date: Jul. 17, 2025

(54) DYNAMIC LIGHT SENSOR AUGMENTED IMAGE ENHANCEMENT

(71) Applicant: VISTEON GLOBAL TECHNOLOGIES, INC., Van Buren Township, MI (US)

(72) Inventor: Paul Fredrick Luther Weindorf, Novi, MI (US)

(73) Assignee: VISTEON GLOBAL TECHNOLOGIES, INC., Van Buren Township, MI (US)

(21) Appl. No.: 19/015,992

(22) Filed: Jan. 10, 2025

Related U.S. Application Data
(60) Provisional application No. 63/620,255, filed on Jan. 12, 2024.
(60) Provisional application No. 63/620,257, filed on Jan. 12, 2024.
(60) Provisional application No. 63/620,264, filed on Jan. 12, 2024.

(51) Int. Cl. G06T 5/40; G01J 1/42; G06T 5/90

(52) U.S. Cl. CPC G06T 5/40; G01J 1/4204; G06T 5/90; G06T 2207/10024; G06T 2207/20208

(57) ABSTRACT

An image enhancement system includes an ambient light sensor, a circuit and a processor. The ambient light sensor is operational to measure an ambient light level. The circuit is operational to: generate a histogram based on an input video signal; export the histogram; receive a gray shade look up table; and generate an output video signal by converting multiple gray shades in the input video signal based on the gray shade look up table. The processor is operational to: receive the histogram; develop the gray shade look up table based on the histogram and the ambient light level; dynamically remap the gray shades in the gray shade look up table in response to the ambient light level to compress a first region of the gray shades and stretch a second region of the gray shades; and transfer the gray shade look up table to the circuit.

### CROSS-REFERENCE TO RELATED APPLICATIONS

This application claims the benefit of U.S. Provisional Application Nos. 63/620,255 filed Jan. 12, 2024, 63/620,257 filed Jan. 12, 2024, and 63/620,264 filed Jan. 12, 2024, which are hereby incorporated by reference in their entirety.

### TECHNICAL FIELD

The present disclosure generally relates to systems and methods for vehicle display image enhancement.

### BACKGROUND

In automotive display applications, light sensors have been utilized to automatically control the display luminance as a function of the ambient lighting environment. As the ambient environment increases, the display luminance increases to maintain visibility of the images. Automatic luminance control methods maintain a comfortable level of viewing brightness, and reduce a display power consumption as the ambient illumination decreases. Although automatic luminance control methods maintain visibility of the symbols for peak-white gray shades, the visibility of lower gray shades may be compromised.

### SUMMARY

An image enhancement system is provided herein. The image enhancement system includes an ambient light sensor, a circuit and a processor. The ambient light sensor is operational to measure an ambient light level. The circuit is operational to: generate a histogram based on an input video signal; export the histogram; receive a gray shade look up table; and generate an output video signal by converting a plurality of gray shades in the input video signal based on the gray shade look up table. The processor is operational to: receive the histogram from the circuit; develop the gray shade look up table based on the histogram and the ambient light level; dynamically remap the plurality of gray shades in the gray shade look up table in response to the ambient light level to compress a first region of the plurality of gray shades and stretch a second region of the plurality of gray shades; and transfer the gray shade look up table to the circuit.

A method for dynamic light sensor augmented image enhancement is provided herein. The method includes measuring an ambient light level with an ambient light sensor, generating a histogram with a circuit based on an input video signal, transferring the histogram from the circuit to a processor, developing the gray shade look up table with the processor based on the histogram and the ambient light level, remapping dynamically the plurality of gray shades in the gray shade look up table with the processor in response to the ambient light level to compress a first region of the plurality of gray shades and stretch a second region of the plurality of gray shades, transferring the gray shade look up table from the processor to the circuit, and generating an output video signal with the circuit by converting a plurality of gray shades in the input video signal based on the gray scale look up table.

A vehicle is provided herein. The vehicle includes an ambient light sensor, a control unit, and a display panel. The ambient light sensor is operational to measure an ambient light level. The control unit includes a circuit and a processor. The circuit is operational to generate a histogram based on an input video signal, export the histogram, receive a gray shade look up table, and generate an output video signal by converting a plurality of gray shades in the input video signal based on the gray scale look up table. The processor is operational to receive the histogram from the circuit, develop the gray shade look up table based on the histogram and the ambient light level, dynamically remap the plurality of gray shades in the gray shade look up table in response to the ambient light level to compress a first region of the plurality of gray shades and stretch a second region of the plurality of gray shades, and transfer the gray shade look up table to the circuit. The display panel is operational to generate an image in response to the output video signal.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a platform.

FIG. 2 illustrates a graph of overlay plots on a Burnette adaptation.

FIG. 3 illustrates a graph of an image enhancement gray shade transfer function.

FIG. 4 illustrates a graph of a histogram and a transfer function of an image.

FIG. 5 illustrates a graph of a dynamic Adaptive Image Enhancement principle.

FIG. 6 illustrates an intermediate functional block diagram of a system.

FIG. 7 illustrates a graph where the new detection threshold is less than a current detection threshold.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a dynamic light sensor augmented image enhancement system. The dynamic light sensor augmented image enhancement system generally moves a detection threshold of Nₘₐₓ points dynamically as a function of a light sensor(s) input to maintain display visibility. Where used with an offset gamma image enhancement function, the original gray shade transfer function is maintained under dark conditions.

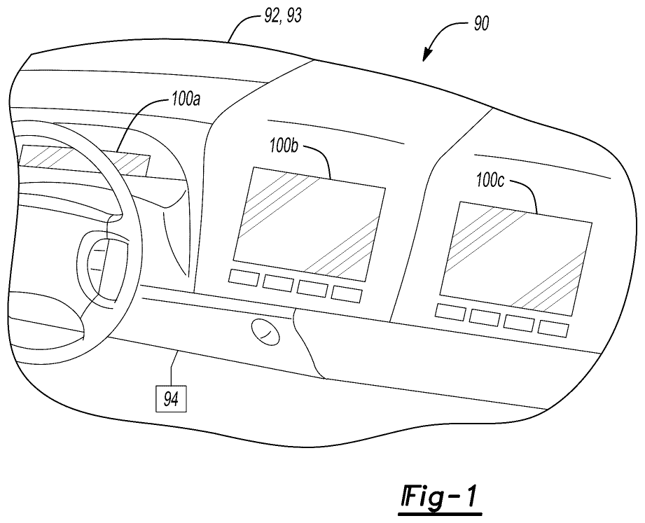

FIG. 1 illustrates a context of a platform 90 in accordance with one or more exemplary embodiments. The platform 90 generally includes an instrument panel 92. The instrument panel 92 includes a control unit 94 and one or more display panels 100a-100c. The instrument panel 92 may be implemented as part of a vehicle 93. The vehicle 93 may include mobile vehicles such as automobiles, trucks, motorcycles, boats, trains and/or aircraft. In some embodiments, the instrument panel 92 may be part of a stationary object. The stationary objects may include, but are not limited to, billboards, kiosks, and/or marquees. Other types of platforms 90 may be implemented to meet the design criteria of a particular application.

The control unit 94 implements one or more display-drive circuits. The control unit 94 is generally operational to generate control signals that drive the display panels 100a-100c. In various embodiments, the control signals may be configured to provide instrumentation (e.g., speed, tachometer, fuel, temperature, etc.) to at least one display panel 100a-100c (e.g., 100a). In some embodiments, the control signals may also be configured to provide video (e.g., a rear-view camera video, a forward-view camera video, an onboard DVD player, etc.) to the display panels 100a-100c. In other embodiments, the control signals may be further configured to provide alphanumeric information shown on one or more of the display panels 100a-100c.

In various embodiments, the control unit 94 generally comprises at least one microcontroller. The at least one microcontroller may include one or more processors, each of which may be embodied as a separate processor, an application specific integrated circuit (ASIC), a field programmable gate array (FPGA), or a dedicated electronic control unit.

The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry. The at least one microcontroller may be embedded as part of an FPGA or ASIC device.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components in the platform 90 and communicate instructions to the display panels 100a-100c through one or more control signals to control the displays panels 100a-100c.

The display panels 100a-100c are generally mounted to the instrument panel 92. In various embodiments, one or more of the display panels 100a-100c may be disposed inside the platform 90 (e.g., vehicle 93). In other embodiments, one or more of the display panels 100a-100c may be disposed exterior to the platform 90. One or more display panels 100a-100c may implement an active public/privacy viewing modes. One or more display panels 100a-100c may also implement the privacy mode. As illustrated, the display panel 100a may be a cluster display positioned for use by a driver. The display panel 100b may be a console display positioned for use by the driver and a passenger. The display panel 100c may be a passenger display positioned for use by the passenger and the driver.

### Introduction

Adaptive Image Enhancement (AIE) offers a method to be able to see lower gray shade content of a display image. Previously, automatic luminance control methods used light sensor information to increase or decrease the luminance level of a display. The previous methods only addressed the visibility of the upper gray shades in a video image. The lower gray shades however remained largely not visible due to the reflected luminance of the display overwhelming and washing out the lower gray shade luminance levels. With the advent of adaptive image enhancement methods, the luminance of the lower gray shades may be increased to the level of visibility with just increasing the overall luminance of the display. However, the control techniques to automatically control both the video path and the display luminance functions may be integrated to provide seamless operation.

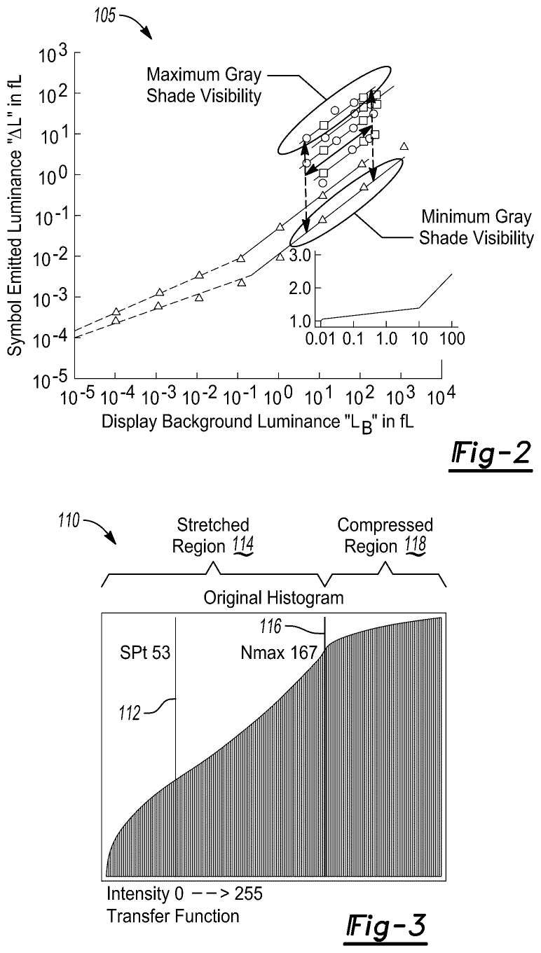

FIG. 2 illustrates a graph 105 of example overlay plots on a Burnette adaptation in accordance with one or more exemplary embodiments. An idea is to separately control the minimum gray shade and the maximum gray shades luminance values according to the figure. Lower gray shades are generally used for accentuation or color themes and generally do not contain special driver information. Therefore, it is reasonable that the lower gray shades follow the “minimum threshold legibility” curve as shown in the FIG. 2. Additional details of the Burnette studies may be found in the paper “The Status of Human Perceptual Characteristics Data for Electronic Flight Display Design”, Proceedings of AGARD Conference No. 96 on Guidance and Control Displays, Paris, France, 1972, by K. T. Burnette, which is hereby incorporated by reference in its entirety.

The maximum values are controlled by setting the maximum display luminance while the minimum value is set using the gray scale function. As the reflected background luminance changes (x-axis), the minimum gray shade luminance and the maximum gray shade luminance should be automatically changed to the y axis display luminance values. Note that the double arrow dashed lines indicate the range that the display luminance gray shades are changed in between. As the reflected background increases, the double arrow dashed line range moves to the right as indicated by the horizontal double arrow. Until the advent of the adaptive image enhancement, only the top maximum visibility curve were realized by adjusting the backlight. However, by adjusting the video gray shades using the adaptive image enhancement, the bottom minimum visibility curve may now be realized resulting in visibility of the lower gray shades that normally are “washed out” by the attending reflected background luminance. In addition to adjusting the backlight level to control the maximum gray shade visibility, the amount of AIE gray shade stretching may be adjusted as a function of the ambient light sensor value(s) in order to minimize image enhancement artifacts as the background luminance is decreased. The ambient light sensor is provided to measure the ambient light level and is proportional to the background luminance seen by the viewer.

### Background

There are two aspects that are considered for implementation of the adaptive image enhancement. First, a Low Video Enhancement (LVE) method may keep gray shade 1 at the appropriate luminance for visibility independent of the commanded maximum display luminance. Therefore, the maximum display white luminance and the minimum gray shade 1 luminance values may be independently controlled. Second, similar to automatic luminance control methods, the LVE gray shade 1 luminance may be adjusted as a function of both the reflected luminance from the display and the luminance the user experiences looking out of the front windshield (adaptation factor). The luminance entering the front windshield may be measured by a forward-looking light sensor. Other luminance within the vehicle may be measured by an ambient light sensor.

Instead of just controlling the display luminance level for the upper visibility level, an additional enhancement is to change the amount of image enhancement stretching as a function of the ambient illumination level. Anytime image enhancement is used, one portion of the transfer curve is stretched while another region is compressed as shown in FIG. 3, as follows.

Although with image enhancement the image is more visible in high sunlight ambient environments, the image artifacts (errors) in the compression area become more visible under reduced ambient lighting conditions. In addition, under low ambient lighting conditions, the image may appear too bright. Therefore, the amount of image stretching may be modified as a function of the ambient illumination level.

FIG. 3 illustrates a graph 110 of an example image enhancement gray shade transfer function in accordance with one or more exemplary embodiments. An issue with automatic luminance control is that the lower video gray shade content becomes less visible under reflected ambient lighting conditions and increasing the display luminance does little for lower video content visibility. An image enhancement function is used to change the shape of the video transfer function dynamically as a function of the ambient lighting conditions. The video transfer function as depicted in FIG. 3 has the input video gray shades on the x-axis and the output video gray shades are on the ordinate axis. Therefore, the input video gray shades are mapped to the output video gray shades as determined by the image enhancement transfer function. For example, if sunlight is shining on the display, the user may see a reflected background from the display commonly known as glare. The glare may make the lower video gray shades difficult to see since the glare is higher in luminance than the lower video gray shades. To make the lower gray shades visible, the lower gray shades (e.g., to the left of the line 116) may be mapped (e.g., stretched region 114) to higher output gray shades thereby increasing the lower gray shade luminance values and making them visible. Higher gray shades (e.g., to the right of an N_{Max} line 116) may be mapped differently (e.g., compressed region 118). Due to the non-linear shape of the transfer function, ratios of the color mixtures may result in a color shift as the shape of the curve changes as a function of the ambient illumination level.

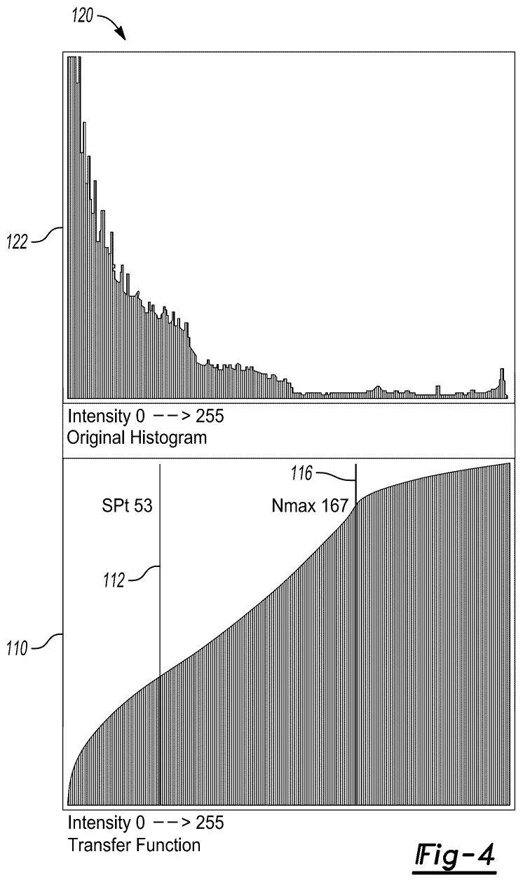

FIG. 4 illustrates a graph 120 an example histogram 122 and the transfer function (graph 110) of an image in accordance with one or more exemplary embodiments. The image histogram 122 illustrated in the figure is primarily used to determine if little higher shade content (e.g., on the right side of the histogram 122 above the N_{Max} line 116) exists in the image in order to allow the lower shades (e.g., on the left side of the histogram 122) to be stretched. Furthermore, low video enhancement basically offsets the image such that the lower gray shade levels may become visible.

FIG. 5 illustrates a graph 200 of an example dynamic Adaptive Image Enhancement (AIE) principle in accordance with one or more exemplary embodiments. An original luminance output L_{O} (curve 202) may be shifted to a new luminance output L_{ONew} (curve 204). An original breakpoint N_{Max} (line 206) may be shifted to a new breakpoint N_{MaxNew} (line 208).

FIG. 6 illustrates an example intermediate functional block diagram of a system in accordance with one or more exemplary embodiments. In various embodiments, the diagram 230 may be implemented with a field programmable gate array (FPGA) or application specific integrated circuit (ASIC) 232 connected to a vehicle interface processor (VIP) 234 or other processor. Each of the blocks in the diagram are described as follows:

### Pixel Luminance Converter Block 236:

The pixel luminance converter block 236 converts every RGB pixel into a monochrome gray shade value.

### Gray Scale Data Accumulators Block 238:

Each pixel is converted into a monochrome gray scale value per Equation 101 and a value of 1 is added for each pixel to each corresponding gray scale accumulator consisting of GS_{Max} accumulators for each frame. For 8-bit video, this would use 256 accumulators. Histogram data is sent to the vehicle interface processor 234 at the end of each video frame. In addition, a Frame End Trigger (FET) is sent to the vehicle interface processor 234 indicating that the accumulators are ready to be down loaded to the vehicle interface processor 234. In addition, the frame end trigger is used to trigger the uploading of the AIE-LVE assignment table in preparation for the next frame of video conversion. Finally, the frame end trigger is used to signal that the new light sensor data is to be sampled. The light sensor sampling generally occurs once per frame cycle such that all functions used the same filtered data L_{BG} light sensor data for each frame.

### Metadata AIE-LVE Bypass Selector Block 240:

The function of bypass selector block 240 is to use the metadata embedded in the video stream to determine safety related or other video symbols to which the AIE-LVE enhancement is not to be applied. In this case, the AIE-LVE assignment table is not utilized and the video for the areas are sent directly to the display.

### Video Gray Shade Assignment Table Block 242:

The gray shade assignment table block 242 utilizes the AIE-LVE assignment table to convert the incoming video gray shade values into the enhanced video gray shade values. Table 1 is an example of a video look up table that is uploaded by the FPGA or ASIC 232 during the video vertical blanking time in preparation for the next active video time period. The output from the gray scale assignment table may be either 10-bit video or 11-bit video.

### 10-Bit or 11-Bit Frame Rate Control Block 244:

The frame rate control block 244 applies frame rate control (FRC) methods to convert the 10-bit (or 11-bit) video data to dithered 8-bit video.

### Gray Shade Detection Threshold Determination Block 246:

The gray shade detection threshold determination block 246 determines the maximum gray scale number such that a specific percentage of the pixels are above a threshold percentage. Therefore, the method starts at a highest accumulator and keeps adding the next lower accumulator value until the threshold percentage is determined for the corresponding gray shade value. This is the GS_{Max} N value used for stretching the dynamic video range after being filtered into variable N_{Max} by the rate limiting filter.

### Max Gray Shade Filter Block 248:

The filter block 248 is a rate limiter whereby the N_{Max} value in incremented or decremented by one gray shade value (8-bit) towards the GS_{Max} value each TL time increment. The rate of the filter is set by the TL time increment input.

### Backlight Level Block 250:

A commanded backlight pulse width modulation (PWM) level is obtained and used to determine the display luminance.

### Light Sensor Pre-Filter Block 252:

In response to the Frame End Trigger (FET), N samples of the light sensor are successively measured and averaged resulting in the variable L_{BGNew}.

### Light Sensor Filter Block 254:

The light sensor value obtained in block 252 is further filtered according to Equation 105 to obtain a faster exponential rise time of about 1 second than the fall time of about 60 seconds to mimic the eye adaptation times of the human visual system and to provide a peak detector function for the picket fence effects.

### LMax Determination Block 256:

The user observed maximum luminance is determined and is the summation of the end point display luminance (reference Block 270) and the reflected background luminance, LBG.

### Gray Shade 0 Calculator Block 258:

Gray shade 0 (GS0) needs to be handled as a special case. If there is no active privacy function on the display, GS0 is set to 0 nits to obtain the appearance of a black display where no information is present. If the display does have the privacy function active, the GS0 background luminance may be raised to reduce the contrast ratio of the image. In various embodiments, the Weber Fraction level may be less than 25 for low black luminance values.

The Weber Fraction is the amount of white crosstalk that the driver sees when observing the passenger display. The “Fraction” is the amount of white luminance seen divided by the black luminance that the driver sees.

### LMin Determination Block 260:

A minimum luminance level for the assignment table calculation is based on the larger of the Weber Fraction black luminance level calculated or the minimum luminance level calculated for display visibility.

### Assignment Table Calculator Block 262:

The assignment table calculation may have two parts. A first part is the calculation for the “black” level G_{S0}. A second calculation involves first choosing which assignment table calculation method may be utilized based on the “Table Select” command.
1. Constant Contrast Ratio Assignment Table 264; or
2. Gamma Assignment Table 266.

### Constant Contrast Ratio Assignment Table 264:

The process of calculating the intermediate input video gray shade values GS₁ through GS_{NMax} between L_{Min} and L_{Max} such that each successive gray shade has the same contrast ratio taking the reflected ambient into account the reflected ambient.

### Gamma Assignment Table 266:

The process of calculating the intermediate input video gray shade values GS₁ through GS_{NMax} between L_{Min} and L_{Max} such that each of the gray shades follow an offset gamma function are determined.

### Assignment Table Modifiers Block 268:

Block 268 provides an assignment table developed per Block 262 and is modified by multiplying other shaping functions.

### End Point Backlight Level Block 270:

Block 270 provides some overhead luminance that may be used in conjunction with AIE. If AIE is not used, or no overhead is desired, the input variable “% End Point Overhead” is set to zero. The end point modifier function in Block 268 may be activated if the “% End Point Overhead” is not zero.

### Selector S1, Metadata Control:

The selector S1 block 272 has two functions. If the metadata control is activated, the metadata is used to either bypass the AIE-LVE video assignment table or use the assignment table as a function of the metadata. If the metadata control is deactivated, the assignment table is used for all video data.

### Selector S2, FRC Bypass Control:

The selector S2 block 274 controls whether the Frame Rate Control function is utilized. If the display has a native 10-bit or 11-bit video input, the FRC function may be bypassed.

### Selector S3, Assignment Table Upload Control:

The selector S3 block 276 is triggered to upload the video assignment table as a function of the Frame End Trigger (FET) emanating from the FPGA (or ASIC) when the last video pixel for the current frame has been received. The video assignment table is to be uploaded during the video vertical blanking time in preparation for the next frame.

### Selector S4, AIE Activation Control:

The selector S4 block 278 control activates the AIE stretching function. If AIE stretching is not activated, N_{Max} is set to 255 and therefore all input gray shades (e.g., 0-255) are formulated to have a constant contrast ratio or gamma offset between L_{Min} and L_{Max}. If however the AIE stretching function is activated, N_{Max} is set according to the filtered video accumulator threshold per Blocks 246 and 248.

### Selector S5, Active Privacy Control:

The selector S5 block 280 control is utilized to activate raising the black gray shade 0 luminance, LG_{S0}, to a level required to meet the Weber Fraction criteria. This has the effect of raising the black level for both the driver and the passenger. Since the black level luminance, LG_{S0}, is a function of the (ambient) light sensor determined background luminance, LBG, as the reflected background luminance increases towards daylight conditions, the black level luminance, LG_{S0}, is decreased such that under daytime conditions the black gray shade luminance is not increased.

### N_{MaxNew} Determination:

The N_{MaxNew} determination block 282 adjusts the N_{Max} gray shade to a new value to move the transfer function such that the luminance is decreased to the level appropriate to maintain display visibility at the N_{Max} gray shade.

### Selector S6, Threshold Control:

The selector S6 block 284 control is utilized to select among the GS_{Max8bit} value and the N_{NewMax} value for use by the Max gray Shade Rate limiter block 248.

The methodology of how much the stretching should be decreased as the ambient light level is lowered, is complex and many possible solutions exist. In various embodiments, the stretching is based on the premise that most of the image is stretched below the N_{Max} input gray shade level (inflection point) as shown in the histogram per FIG. 4. The example in FIG. 4 shows that 95% of the pixels have input gray shade levels below input gray shade 167. Since most of the mage luminance is controlled to be highest at the N_{Max} input gray shade, the luminance at the N_{Max} location may be lowered as a function of the ambient light level by increasing the N_{Max} gray shade to a new N_{MaxNew} gray shade level as depicted in FIG. 5. As shown in FIG. 5, the ideal is to move the transfer function such that the luminance is decreased to the level appropriate to maintain display visibility at the N_{Max} gray shade. By taking such an approach, the image is less stretched under lower ambient lighting levels and a new N_{MaxNew} threshold point is utilized. The idea of this approach is to calculate a new threshold, N_{MaxNew}, based on the light sensor data and to use the new threshold value instead of N_{Max} value in the method. FIG. 6 shows the Block 282 that determines the dynamic N_{NewMax} value.

### Dynamic Adaptive Image Enhancement N_{MaxNew} Determination Method

There are two assignment table determination methods as shown in Block 262 to consider: 1. a Gamma Table and 2. a Constant Contrast Ratio Table

### The Gamma Table Method:

Starting with the gamma table method, Equation 1, as follows, is the starting point to determine the dynamic N_{MaxNew} value.

$${L}_{DMax} {( \frac{{GS}_{N}}{{2}^{N} New - 1} )}^{{γ}_{D}} = ( {L}_{Max} - {L}_{Min} ) {( \frac{N}{{N}_{Max}} )}^{{γ}_{G}} + ( {L}_{Min} - {L}_{BG} ) \qquad Eq . ( 1 )$$

Where:
L_{DMax} is the display maximum luminance value (nits).
GS_{N} is a new mapped gray shade value.
N_{New} is a number of bits for an output of an assignment table calculator.
γ_{D} is a gamma value for the display.
N_{MAX} is a current threshold (inflection point).
L_{Max} is a maximum luminance end point.
γ_{G} is a new desired gamma value (offset gamma).
L_{Min} is a minimum luminance end point.
N is an input gray shade number 1-255.
N_{Max} is a maximum input gray shade determined from the input video chronometric data.
L_{BG} is a background (or ambient) luminance.

The left hand term in Equation 1 is the same as display luminance, L_{O}, and therefore Equation 1 may be rewritten as Equation 2 as follows:

$${L}_{O} = ( {L}_{Max} - {L}_{Min} ) {( \frac{N}{{N}_{Max}} )}^{{γ}_{G}} + ( {L}_{Min} - {L}_{BG} ) \qquad Eq . ( 2 )$$

Per Block 260, L_{Min} is defined per Equation 3 as follows:

$${L}_{Min} = {B}_{O} {( {L}_{BG} )}^{C} + {L}_{BG} \qquad Eq . ( 3 )$$

Where:
B_{O} is a luminance offset constant.
c is a power constant.

Substituting Equation 3 into Equation 2 yields Equation 4 as follows:

$${L}_{O} = ( {L}_{Max} - {L}_{Min} ) {( \frac{N}{{N}_{Max}} )}^{{γ}_{G}} + {B}_{O} {( {L}_{BG} )}^{C} \qquad Eq . ( 4 )$$

Per Block 256, L_{Max} is defined per Equation 5 as follows:

$${L}_{Max} = {L}_{DLimit} + {L}_{BG} \qquad Eq . ( 5 )$$

Thereafter, using Equations 3 and 5, L_{Max}−L_{Min} may be composed as shown in Equation 6 as follows:

$${L}_{Max} - {L}_{Min} = {L}_{DLimit} + {L}_{BG} - ( {B}_{O} {( {L}_{BG} )}^{C} + {L}_{BG} ) \qquad Eq . ( 6 )$$

Equation 6 may be simplified as Equation 7 as follows:

$${L}_{Max} - {L}_{Min} = {L}_{DLimit} - {B}_{O} {( {L}_{BG} )}^{C} \qquad Eq . ( 7 )$$

Substituting Equation 7 into Equation 4 results in Equation 8 as follows:

$${L}_{O} = ( {L}_{DLimit} - {B}_{O} {( {L}_{BG} )}^{C} ) {( \frac{N}{{N}_{Max}} )}^{{γ}_{G}} + {B}_{O} {( {L}_{BG} )}^{C} \qquad Eq . ( 8 )$$

L_{DLimit} is defined per Block 270 as shown by Equation 9 as follows:

$${L}_{DLimit} = ( 1 - ( \frac{{\%}_{EPOH}}{100} ) [ \frac{255 - {N}_{Max}}{255} ] ) \times {L}_{DMax} \qquad Eq . ( 9 )$$

Substituting Equation 9 into Equation 8 yields the Equation 10 as follows:

$${L}_{O} = [ [ 1 - ( \frac{{\%}_{E P O H}}{100} ) [ \frac{255 - {N}_{Max}}{255} ] ] {L}_{DMax} - {{B}_{O} ( {L}_{B G} )}^{C} ] {( \frac{N}{{N}_{Max}} )}^{{γ}_{G}} + {{B}_{O} ( {L}_{B G} )}^{C} \qquad Eq . ( 10 )$$

The idea is to set N=N_{Max} in Equation 10 so that the luminance output. L_{O}, may be controlled at the N_{Max} threshold. In addition, the N_{Max} variable is changed to N_{MaxNew} with the idea that the Equation 10 may be used to solve for new N_{MaxNew} value for a particular luminance level, L_{O}, at gray shade N=N_{Max} as shown in FIG. 5. Equation 11, as follows, shows how Equation 10 is transformed to solve for the new N_{MaxNew} value.

$${L}_{O} = [ [ 1 - ( \frac{{\%}_{E P O H}}{100} ) [ \frac{255 - {N}_{MaxNew}}{255} ] ] {L}_{DMax} - {{B}_{O} ( {L}_{B G} )}^{C} ] {( \frac{{N}_{Max}}{{N}_{MaxNew}} )}^{{γ}_{G}} + {{B}_{O} ( {L}_{B G} )}^{C} \qquad Eq . ( 11 )$$

L_{O} may then be determined as a function of the lighting level according to Equation 12 as follows:

$${L}_{O} = {{B}_{O H} ( {L}_{B G} )}^{{C}_{H}} \qquad Eq . ( 12 )$$

Where B_{OH} and C_{H} are the desired Fechner constants.

Equation 12 may be substituted into Equation 11 resulting in Equation 13 as follows:

$${{B}_{O H} ( {L}_{B G} )}^{{C}_{H}} = {{B}_{O} ( L B G )}^{C} + [ [ 1 - ( \frac{{\%}_{E P O H}}{100} ) [ \frac{255 - {N}_{MaxNew}}{255} ] ] {L}_{DMax} - {{B}_{O} ( {L}_{B G} )}^{C} ] {( \frac{{N}_{Max}}{{N}_{MaxNew}} )}^{{γ}_{G}} \qquad Eq . ( 13 )$$

Recognize that Equation 13 is not deterministic towards solving for N_{MaxNew} because the variable is located in two places, one of which is to the gamma power. Since Equation 14, as follows, cannot be solved for N_{MaxNew}, a course of action is to solve the Equation 14 for possible values of N_{MaxNew} (e.g., 0 to 255) and to find the value that is closest to the desired output luminance, L_{O}, at N_{Max}. The N_{MaxNew} may be limited between GS_{Max8bit} and 255 to be used in Block 262 after the rate limiter block 248. An aspect of the implementation is that if the background luminance is increased sufficiently, N_{MaxNew} may become less that N_{Max} if not limited by N_{Max}.

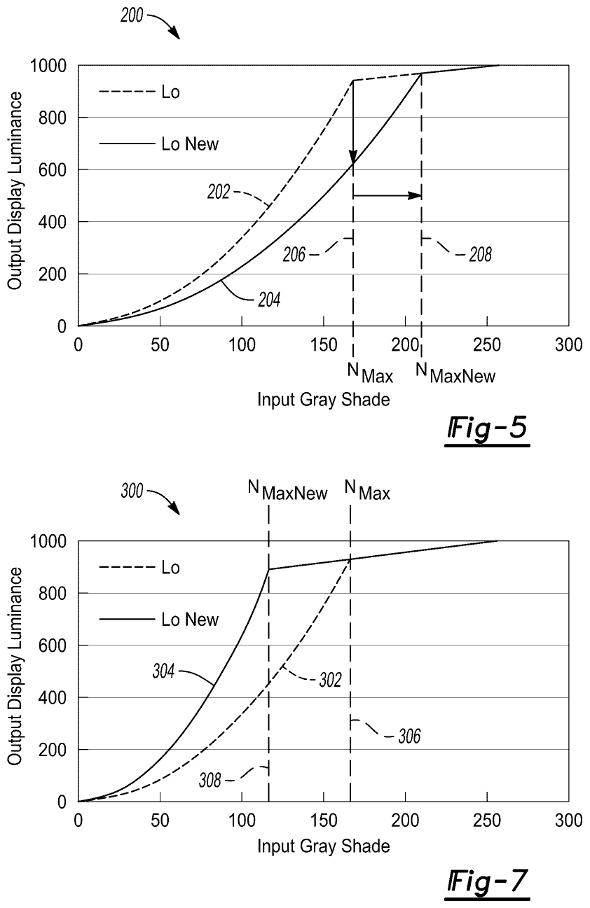

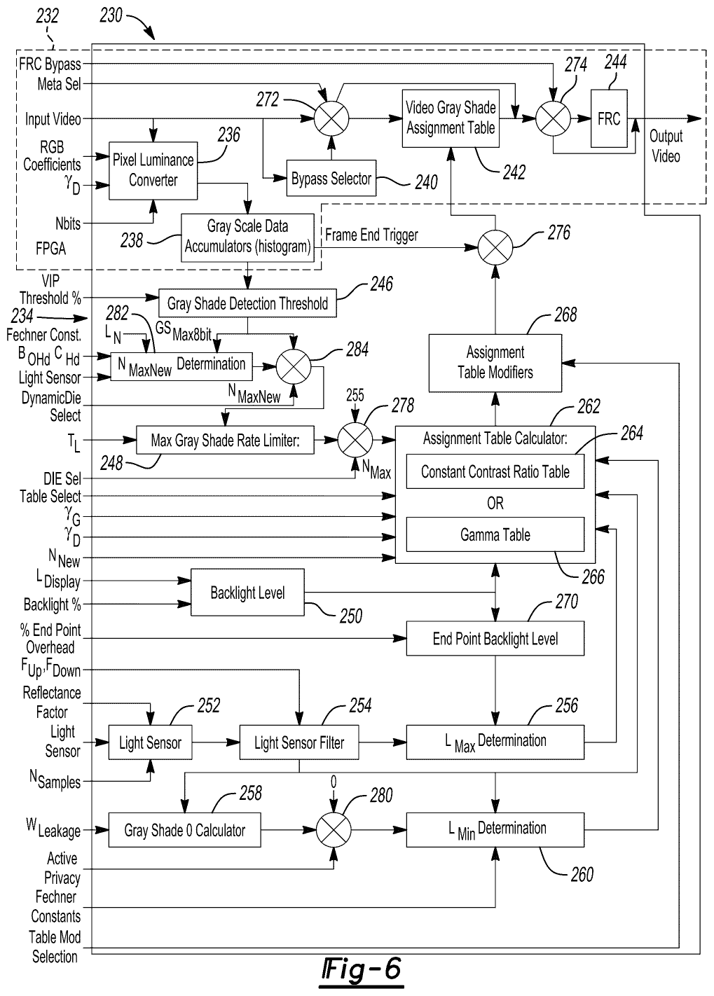

FIG. 7 illustrates an example graph 300 where the new detection threshold is less than a current detection threshold if L_{BG} is increased in accordance with one or more exemplary embodiments. The original luminance output L_{O} (curve 302) may be shifted to a new luminance output L_{ONew} (curve 304). Therefore, the new detection threshold N_{MaxNew} (line 308) is less than a current detection threshold N_{Max} (line 306).

### Constant Contrast Ratio Table Method:

The constant contrast ratio table method starts with Equation 14, as follows, as the starting point to determine the dynamic N_{MaxNew} value.

$$G {S}_{N} = ( {2}^{{N}_{N e w}} - 1 ) {{L}_{DMax}^{( - 1 / {γ}_{D} )} [ {{[ {L}_{Max} ]}^{( \frac{N - 1}{{N}_{Max} - 1} )} [ {L}_{Min} ]}^{( \frac{{N}_{Max} - N}{{N}_{Max} - 1} )} - {L}_{B G} ]}^{( \frac{1}{{γ}_{D}} )} \qquad Eq . ( 14 )$$

In order to convert to luminance, Equation 15, as follows, may be utilized:

$${L}_{G {S}_{N}} = {{L}_{DMax} ( \frac{G {S}_{N}}{{2}^{N} New - 1} )}^{γ} \qquad Eq . ( 15 )$$

Substituting Equation 14 into Equation 15 yields Equation 16 as follows:

$${L}_{O} = [ {{[ {L}_{Max} ]}^{( \frac{N - 1}{{N}_{Max} - 1} )} [ {L}_{Min} ]}^{( \frac{{N}_{Max} - N}{{N}_{Max} - 1} )} - {L}_{BG} ] \qquad Eq . ( 16 )$$

Per Block 260 in FIG. 6, L_{Min} is defined per Equation 17 as follows:

$${L}_{Min} = {{B}_{O} ( {L}_{B G} )}^{C} + {L}_{B G} \qquad Eq . ( 17 )$$

Per Block 256 in FIG. 6, L_{Max} is defined per Equation 18 as follows:

$${L}_{Max} = {L}_{D L i m i t} + {L}_{B G} \qquad Eq . ( 18 )$$

Substituting Equation 17 and Equation 18 into Equation 16 yields Equation 19 as follows:

$${L}_{O} = {{[ {L}_{D L i m i t} + {L}_{B G} ]}^{( \frac{N - 1}{{N}_{Max} - 1} )} [ {{B}_{O} ( {L}_{BG} )}^{C} + {L}_{BG} ]}^{( \frac{{N}_{Max} - N}{{N}_{Max} - 1} )} - {L}_{BG} \qquad Eq . ( 19 )$$

L_{DLimit} is defined per Block 270 in FIG. 6 as shown by Equation 20 as follows:

$${L}_{D L i m i t} = ( 1 - ( \frac{{\%}_{E P O H}}{100} ) [ \frac{255 - {N}_{Max}}{255} ] ) \times {L}_{DMax} \qquad Eq . ( 20 )$$

Substituting Equation 20 into Equation 19 yields Equation 21 as follows:

$${L}_{O} = {[ ( 1 - ( \frac{{\%}_{E P O H}}{100} ) [ \frac{255 - {N}_{Max}}{255} ] ) {L}_{DMax} + {L}_{B G} ]}^{( \frac{N - 1}{{N}_{Max} - 1} )} \times {[ {{B}_{O} ( {L}_{B G} )}^{C} + {L}_{B G} ]}^{( \frac{{N}_{Max} - N}{{N}_{Max} - 1} )} - {L}_{BG} \qquad Eq . ( 21 )$$

The idea is to set N=N_{Max} in Equation 21 so that the luminance output, L_{O}, may be controlled at the N_{Max} threshold. In addition, the N_{Max} variable is changed to N_{MaxNew} with the idea that the Equation 21 may be used to solve for a new N_{MaxNew} value for a particular luminance level, L_{O}, at gray shade N=N_{Max} as shown in FIG. 5. Equation 22, as follows, shows how Equation 21 is transformed to solve for the new N_{MaxNew} value:

$${L}_{O} = {[ ( 1 - ( \frac{{\%}_{E P O H}}{100} ) [ \frac{255 - {N}_{MaxNew}}{255} ] ) {L}_{DMax} + {L}_{B G} ]}^{( \frac{{N}_{Max} - 1}{{N}_{{MaxNew}^{- 1}}} )} \times {[ {{B}_{O} ( {L}_{B G} )}^{C} + {L}_{B G} ]}^{( \frac{{N}_{MaxNew} - {N}_{Max}}{{N}_{{MaxNew}^{- 1}}} )} - {L}_{B G} \qquad Eq . ( 22 )$$

L_{O} may then be determined as a function of the lighting level according to Equation 23 as follows:

$${L}_{O} = {{B}_{O H} ( {L}_{B G} )}^{{C}_{H}} \qquad Eq . ( 23 )$$

Where B_{OH} and C_{H} are the desired Fechner constants.

Equation 23 may be substituted into Equation 22 resulting in Equation 34 as follows:

$${{B}_{O H} ( {L}_{B G} )}^{{C}_{H}} = {[ ( 1 - ( \frac{{\%}_{E P O H}}{100} ) [ \frac{255 - {N}_{MaxNew}}{255} ] ) {L}_{DMax} + {L}_{B G} ]}^{( \frac{{N}_{Max} - 1}{{N}_{{MaxNew}^{- 1}}} )} \times {[ {{B}_{O} ( {L}_{B G} )}^{C} + {L}_{B G} ]}^{( \frac{{N}_{MaxNew} - {N}_{Max}}{{N}_{{MaxNew}^{- 1}}} )} - {L}_{B G} \qquad Eq . ( 24 )$$

In a similar manner as to what was done for the gamma function method, Equation 24 may be used instead of Equation 13.

### Dynamic AIE Implementation:

A graphical user interface (GUI) implementing embodiments of the present disclosure may include the following. A “Dynamic Light” box is checked blue while the dynamic AIE is activated. While the “Limit N_{MaxNew}” box is checked blue, the N_{MaxNew} is not allowed to go below the GS_{Max8bit} value calculated by Block 246 in FIG. 6. Otherwise, the dynamic AIE function may provide additional image enhancement by decreasing the Nmaxnew value below the GS_{Max8bit} while the “Limit N_{MaxNew}” is not checked blue.

Additionally, the dynamic AIE GUI generally allows track bar control of the Fechner constants “BO H” and “C H” that corresponds to B_{OH} and C_{H}, as outlined in Equation 12. In various embodiments, the Fechner Constants may be labeled as B_{OHd} and C_{Hd} to show association with the “d”ynamic AIE feature.

The following examples are provided to show how the Dynamic AIE feature operates. Dynamic Fechner values of B_{O}=44.3 and C=0.8 were used.

While the Dynamic AIE is activated and light sensor value is lowered to around 2000 Lux, the N_{Max} value may be increased to from 167 to 219.

While the Dynamic AIE is activated, the N_{Max} limit is not activated, and with the original 5000 Lux, then the N_{Max} value is allowed to go to 133, which is below the original 167. As would be expected the output histogram is dramatically expanded from the original output histogram showing the dynamic nature of the dynamic AIE method to control the stretching not only as a function of the Threshold %, but also as a function of the light sensor value.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. An image enhancement system comprising:
an ambient light sensor operational to measure an ambient light level;
a circuit operational to:
generate a histogram based on an input video signal;
export the histogram;
receive a gray shade look up table; and
generate an output video signal by converting a plurality of gray shades in the input video signal based on the gray scale look up table; and
a processor operational to:
receive the histogram from the circuit;
develop the gray shade look up table based on the histogram and the ambient light level;
dynamically remap the plurality of gray shades in the gray shade look up table in response to the ambient light level to compress a first region of the plurality of gray shades and stretch a second region of the plurality of gray shades; and
transfer the gray shade look up table to the circuit.

2. The image enhancement system according to claim 1, wherein the processor is further configured to:
dynamically change an inflection point value between the first region and the second region such that a luminance generated at the inflection point value in the histogram is controlled to maintain visibility according to a fractional power function.

3. The image enhancement system according to claim 1, wherein the processor is further configured to:
dynamically change the second region according to an offset gamma function where one or more lowest gray shade luminance values are modified to maintain a minimum threshold visibility.

4. The image enhancement system according to claim 3, wherein the processor is further configured to:
dynamically stretch the second region such that under low ambient light conditions an original display gamma function results.

5. The image enhancement system according to claim 3, wherein the processor is further configured to:
dynamically change the second region according to an offset constant contrast ratio function where the one or more lowest gray shade luminance values are modified to maintain the minimum threshold visibility.

6. The image enhancement system according to claim 1, wherein the processor is further configured to:
match a beginning value of the first compressed region to an end value of the second stretched region.

7. The image enhancement system according to claim 1, wherein the processor includes:
a plurality of table modifiers operational to modify one of a plurality of shaping functions for the plurality of gray shades.

8. The image enhancement system according to claim 1, wherein the processor includes:
a gray shade detection threshold operational to determine a maximum gray scale number such that a specific percentage of the pixels are above a threshold percentage.

9. The image enhancement system according to claim 1, wherein the processor includes:
a maximum gray shade rate limiter operational to control a rate at which a breakpoint value in adjusted to a single gray shade value each time increment.

10. The image enhancement system according to claim 1, wherein the circuit includes:
a frame rate controller operational to convert high-dynamic range video data to dithered video.

11. A method for dynamic light sensor augmented image enhancement comprising:
measuring an ambient light level with an ambient light sensor;
generating a histogram with a circuit based on an input video signal;
transferring the histogram from the circuit to a processor;
developing a gray shade look up table with the processor based on the histogram and the ambient light level;
remapping dynamically a plurality of gray shades in the gray shade look up table with the processor in response to the ambient light level to compress a first region of the plurality of gray shades and stretch a second region of the plurality of gray shades;
transferring the gray shade look up table from the processor to the circuit; and
generating an output video signal with the circuit by converting a plurality of gray shades in the input video signal based on the gray scale look up table.

12. The method according to claim 11, further comprising:
changing dynamically with the processor an inflection point value between the first region and the second region such that a luminance generated at the inflection point value in the histogram is controlled to maintain visibility according to a fractional power function.

13. The method according to claim 11, further comprising:
changing dynamically with the processor the second region according to an offset gamma function where one or more lowest gray shade luminance values are modified to maintain a minimum threshold visibility.

14. The method according to claim 13, further comprising:
stretching dynamically with the processor the second region such that under low ambient light conditions an original display gamma function results.

15. The method according to claim 13, further comprising:
changing dynamically with the processor the second region according to an offset constant contrast ratio function where the one or more lowest gray shade luminance values are modified to maintain the minimum threshold visibility.

16. The method according to claim 11, further comprising:
matching with the processor a beginning value of the first compressed region to an end value of the second stretched region.

17. The method according to claim 11, further comprising:
modifying with the processor one of a plurality of shaping functions for the plurality of gray shades.

18. The method according to claim 11, further comprising:
determining with the processor a maximum gray scale number such that a specific percentage of a plurality of pixels are above a threshold percentage.

19. The method according to claim 11, further comprising:
Controlling with the processor a rate at which a breakpoint value in adjusted to a single gray shade value each time increment.

20. A vehicle comprising:
an ambient light sensor operational to measure an ambient light level;
a control unit that includes:
a circuit operational to:
generate a histogram based on an input video signal;
export the histogram;
receive a gray shade look up table; and
generate an output video signal by converting a plurality of gray shades in the input video signal based on the gray scale look up table; and
a processor operational to:
receive the histogram from the circuit;
develop the gray shade look up table based on the histogram and the ambient light level;
dynamically remap the plurality of gray shades in the gray shade look up table in response to the ambient light level to compress a first region of the plurality of gray shades and stretch a second region of the plurality of gray shades; and
transfer the gray shade look up table to the circuit; and
a display panel operational to generate an image in response to the output video signal.
